(19) United States
(12) Patent Application Publication
(10) Pub. No.: US 2025/0004189 A1
(43) Pub. Date: Jan. 2, 2025

(54) LIGHT GUIDE PLATE, DISPLAY DEVICE, GAME MACHINE, AND IN-VEHICLE DISPLAY

(71) Applicant: OMRON Corporation, KYOTO (JP)

(72) Inventors: Yuto MORI, Kyoto-shi (JP); Masayuki SHINOHARA, Kyoto-shi (JP); Yoshihiko TAKAGI, Kyoto-shi (JP); Yasuhiro TANOUE, Kyoto-shi (JP); Junya FUJITA, Kyoto-shi (JP); Masanori MORI, Kyoto-shi (JP); Takeshi KAKINUMA, Kyoto-shi (JP)

(73) Assignee: OMRON Corporation, KYOTO (JP)

(21) Appl. No.: 18/668,232

(22) Filed: May 19, 2024

(30) Foreign Application Priority Data
Jun. 30, 2023 (JP) 2023-108642

(51) Int. Cl. F21V 8/00; G02B 30/33; G07F 17/32

(52) U.S. Cl. CPC G02B 6/006; G02B 6/0038; G02B 6/0068; G02B 30/33; G07F 17/3211

(57) ABSTRACT

A light guide plate includes an incident surface by which a light from a light source enters, an exit surface from which the light exits, and light deflecting parts that cause the light entering from the incident surface and guided to exit from the exit surface. The light deflecting parts are arranged on an arrangement line which is a linear arrangement region. At least one arrangement line includes a region that is not parallel to the incident surface.

### CROSS-REFERENCE TO RELATED APPLICATION

This application claims the priority benefit of Japan application serial no. 2023-108642, filed on Jun. 30, 2023. The entirety of the above-mentioned patent application is hereby incorporated by reference herein and made a part of this specification.

### BACKGROUND

### Technical Field

The disclosure relates to a light guide plate, a display device, a game machine, and an in-vehicle display that display stereoscopic images based on parallax.

### Related Art

Patent Document 1 (Japanese Patent Application Laid-Open No. 2019-139176) discloses a light guide plate that displays stereoscopic images based on parallax. A light from a light source enters the light guide plate via an incident surface which is a lateral surface, and the light guide plate includes a plurality of deflecting parts provided in rows parallel to the incident surface, the deflecting parts each having an inclined surface that reflects the light, which is guided while being totally reflected inside the light guide plate, and causes the light to exit from an exit surface. An orientation of the inclined surfaces of each row changes depending on a distance from the incident surface.

However, in the light guide plate of Patent Document 1, in a region in which a stereoscopic image close to being parallel to the incident surface is displayed, it is necessary to narrow the space between the rows of deflecting parts for displaying the stereoscopic image (details thereof will be described later). In such a region, the transparency of the light guide plate decreases due to an increase in the density of the deflecting parts. Further, in the case where it is desired to display a stereoscopic image with an extremely high parallelism to the incident surface, it is also difficult to display the stereoscopic image as a continuous line image.

### SUMMARY

A light guide plate according to an aspect of the disclosure is a light guide plate which displays a stereoscopic image based on parallax. The light guide plate includes: an incident surface by which a light from a light source enters; an exit surface from which the light exits; and a plurality of light deflecting parts that cause the light entering from the incident surface and guided to exit from the exit surface by deflecting the light. The plurality of light deflecting parts are arranged on an arrangement line which is a linear arrangement region. A point on the exit surface that emits a first exit light deflected by the light deflecting part toward an angular range of irradiating to one eye and a vicinity thereof of an observer observing the exit surface from within an observation space of a predetermined range is defined as a first exit point. A point on the exit surface that emits a second exit light deflected by the light deflecting part toward an angular range of irradiating to the other eye and a vicinity thereof of the observer is defined as a second exit point. The plurality of light deflecting parts arranged on the arrangement line are provided such that a straight line passing through the first exit point and a center of the one eye and a straight line passing through the second exit point and a center of the other eye intersect each other to form an intersection point. The arrangement line is provided as a plurality of arrangement lines, and at least one of the arrangement lines includes a region that is not parallel to the incident surface.

According to the above configuration, the intersection point between the straight line passing through the first exit point and the center of the one eye and the straight line passing through the second exit point and the center of the other eye is formed for each arrangement line. With the plurality of arrangement lines including a region that is not parallel to the incident surface, in the case of displaying a stereoscopic image close to being parallel to the incident surface, the interval between the arrangement lines for displaying the stereoscopic image can be widened, and the density of the light deflecting parts can be reduced. Thus, a light guide plate having a high transparency can be realized even in the case of displaying a stereoscopic image close to being parallel to the incident surface.

Further, in the light guide plate according to an aspect of the disclosure, the intersection point may be located on a depth side of the exit surface as viewed from the observer.

According to the above configuration, the stereoscopic image can be displayed on the depth side of the exit surface.

Further, in the light guide plate according to an aspect of the disclosure, each of the plurality of arrangement lines may be a straight line, a curve, a combination of two or more straight lines, a combination of two or more curves, or a combination of one or more straight lines and one or more curves.

According to the above configuration, the degree of freedom in the movement of the stereoscopic image is improved by switching the position of the light source that causes light to enter the light guide plate or moving the position at which the observer observes the stereoscopic image.

Further, in the light guide plate according to an aspect of the disclosure, each of the plurality of arrangement lines may include a branching point or a merging point of a plurality of lines.

According to the above configuration, it is possible to realize an expression in which the stereoscopic image appears to split or merge along the arrangement lines by switching the position of the light source that causes light to enter the light guide plate or moving the position at which the observer observes the stereoscopic image.

Further, in the light guide plate according to an aspect of the disclosure, each of the plurality of arrangement lines may include a straight line region that is not parallel to each other.

According to the above configuration, it is possible to realize an expression in which the stereoscopic image appears to expand or shrink along the arrangement lines by switching the position of the light source that causes light to enter the light guide plate or moving the position at which the observer observes the stereoscopic image.

Further, in the light guide plate according to an aspect of the disclosure, the stereoscopic image may include a first stereoscopic image displayed by the light deflecting parts in a first partial region which is a region of a part of the light guide plate, and a second stereoscopic image displayed by the light deflecting parts in a second partial region which is a region different from the first partial region. The light deflecting parts may be provided such that the first stereoscopic image and the second stereoscopic image are observable from within the same observation space.

According to the above configuration, the observer can observe the first stereoscopic image and the second stereoscopic image from within the same observation space.

Further, in the light guide plate according to an aspect of the disclosure, the stereoscopic image may include a first stereoscopic image displayed by the light deflecting parts in a first partial region which is a region of a part of the light guide plate, and a second stereoscopic image displayed by the light deflecting parts in a second partial region which is a region different from the first partial region. The light deflecting parts may be provided such that the observation space in which the first stereoscopic image is observable and the observation space in which the second stereoscopic image is observable are arranged at positions different from each other.

According to the above configuration, in the case where the observer observes one of the first stereoscopic image and the second stereoscopic image, reflection of the other can be reduced.

Further, in the light guide plate according to an aspect of the disclosure, an angle formed between the incident surface and a region of each of the plurality of arrangement lines that is not parallel to the incident surface may be 2.5° or more.

According to the above configuration, visibility of a stereoscopic image parallel to the incident surface improves.

Further, a display device according to an aspect of the disclosure includes: the above light guide plate; a plurality of light sources that cause light to enter the light guide plate from the incident surface; and a control part that controls the plurality of light sources.

According to the above configuration, by controlling the plurality of light sources, the control part can change the position of the light source that causes light to enter the light guide plate.

Further, in the display device according to an aspect of the disclosure, the plurality of light sources may be arranged in a linear pattern. The control part may control the plurality of light sources to turn on and turn off sequentially from one end to the other end of a region of the linear pattern.

According to the above configuration, it is possible to realize a control in which the position of the light source that causes light to enter the light guide plate moves from the one end to the other end of the region in which the plurality of light sources are arranged in a linear pattern.

Further, in the display device according to an aspect of the disclosure, the plurality of light sources may be arranged in a linear pattern. The control part may control the plurality of light sources to turn on and turn off sequentially from any point other than one end and the other end of a region of the linear pattern toward both the one end and the other end.

According to the above configuration, it is possible to realize a control in which the position of the light source that causes light to enter the light guide plate moves from a point other than both ends toward the both ends of the region in which the plurality of light sources are arranged in a linear pattern.

Further, a game machine according to an aspect of the disclosure includes the above display device.

According to the above configuration, effects similar to the display device are achieved.

Further, an in-vehicle display according to an aspect of the disclosure includes the above display device.

According to the above configuration, effects similar to the display device are achieved.

According to an aspect of the disclosure, it is possible to realize a light guide plate and the like that are capable of clearly displaying a stereoscopic image close to being parallel to an incident surface and have a high transparency.

### BRIEF DESCRIPTION OF DRAWINGS

FIG. 1 is a plan view showing a configuration of a display device in an embodiment of the disclosure.

FIG. 2 is a cross-sectional view showing a path of light guided by a light guide plate.

FIG. 3 is a perspective view for describing directivity of exit lights exiting from an exit surface of the light guide plate.

FIG. 4 is a perspective view showing an intersection point at which a straight line passing through a first exit point and a center of one eye of an observer intersects with a straight line passing through a second exit point and a center of the other eye of the observer, to illustrate a principle of stereoscopic display based on parallax.

FIG. 5 is a perspective view showing a game machine including the display device of Embodiment 1.

FIG. 6 is a view showing an example of the case where a stereoscopic image having a portion close to being parallel to an incident surface is displayed in a display device serving as a comparative example.

FIG. 7 is a view showing examples of a relationship between an angle formed between arrangement lines and the incident surface and a display of the stereoscopic image in the display device of Embodiment 1.

FIG. 8 is a view showing specific examples of an arrangement of light deflecting parts in the light guide plate.

FIG. 9 is a view showing more specific examples of the arrangement of the light deflecting parts in the light guide plate.

FIG. 10 is a plan view showing an example of a display device according to Embodiment 2.

FIG. 11 is a plan view showing an example of a display device according to Embodiment 3.

FIG. 12 is a plan view showing another example of the display device according to Embodiment 3.

FIG. 13 is a plan view showing still another example of the display device according to Embodiment 3.

FIG. 14 is a view showing a display device according to a first modification example of Embodiment 3.

FIG. 15 is a view showing a display device according to a second modification example of Embodiment 3.

FIG. 16 is a view showing a display device according to a third modification example of Embodiment 3.

FIG. 17 is a view showing a display device according to a fourth modification example of Embodiment 3.

FIG. 18 is a view showing display devices according to Embodiment 4.

FIG. 19 is a view showing display devices according to a modification example of Embodiment 4.

FIG. 20 is a view showing display devices according to another modification example of Embodiment 4 different from that shown in FIG. 19.

FIG. 21 is a view showing examples of the arrangement line according to Embodiment 5.

FIG. 22 is a view showing examples of a light guide plate according to Embodiment 5.

FIG. 23 is a view showing examples of the arrangement line according to Embodiment 6.

FIG. 24 is a view showing examples of a light guide plate according to Embodiment 6.

FIG. 25 is a view showing examples of the arrangement line according to Embodiment 7.

FIG. 26 is a view showing an example of a light guide plate according to Embodiment 7.

FIG. 27 is a view showing specific examples of a control on a light source performed by a control part.

### DESCRIPTION OF EMBODIMENTS

Aspects of the disclosure realize a light guide plate and the like which are capable of clearly displaying a stereoscopic image close to being parallel to an incident surface and have a high transparency.

### Embodiment 1

Hereinafter, an embodiment of the disclosure will be described in detail. In the following description, unless otherwise noted, a numerical range indicated by “A to B” means “A or more and B or less”. Further, in each figure, among components appearing multiple times, there may be cases where only some of the components are labeled with reference signs.

### Application Example

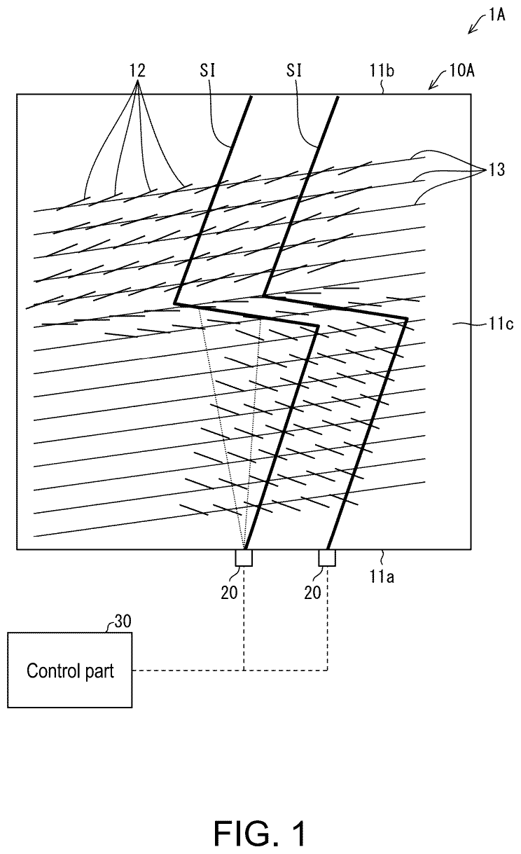

FIG. 1 is a plan view showing a configuration of a display device 1A in an embodiment of the disclosure. First, referring to FIG. 1, an example of a scenario to which the disclosure is applied will be described. As shown in FIG. 1, the display device 1A in the disclosure includes a light guide plate 10A, a light source 20, and a control part 30. For simplicity, illustration of the control part 30 is omitted except in FIG. 1.

The light guide plate 10A displays a stereoscopic image SI based on parallax. In this application example, the light guide plate 10A has a rectangular plate shape in a plan view. In other words, the light guide plate 10A has a rectangular cuboid shape. However, the shape of the light guide plate 10A is not limited thereto. The material of the light guide plate 10A may be, for example, polycarbonate, acrylic, other resins having light transmitting properties, or glass.

The stereoscopic image SI includes one or more line segments or curves. The stereoscopic image SI expresses a character, a figure, a pattern, or the like by a combination of the line segments or curves.

The light guide plate 10A has an incident surface 11a. The incident surface 11a is a surface by which light from the light source 20 enters the light guide plate 10A. The incident surface 11a is one of lateral surfaces of the light guide plate 10A having a rectangular cuboid shape. A lateral surface is a surface adjacent to a main surface in the case where a largest area surface of the rectangular cuboid shape is referred to as the main surface.

Further, the light guide plate 10A has another lateral surface 11b opposed to the incident surface 11a. In the display device 1A, the light source 20 may also be arranged on the lateral surface 11b, and light may also enter the light guide plate 10A from the lateral surface 11b.

Further, the light guide plate 10A has an exit surface 11c. The exit surface 11c is a surface from which light guided inside the light guide plate 10A exits the light guide plate 10A. The exit surface 11c is one of main surfaces of the light guide plate 10A having a rectangular cuboid shape.

Further, the light guide plate 10A includes a plurality of light deflecting parts 12. The light deflecting part 12 deflects the light entering from the incident surface 11a and guided inside the light guide plate 10A to cause the light to exit from the exit surface 11c. The light deflecting part 12 in this embodiment is a V-groove structure extending in a direction corresponding to a position of an observation space with respect to the light guide plate 10A and a display position of the stereoscopic image SI, and a plurality of rows of the light deflecting parts 12 are formed side by side in the incident direction. In the figures, for convenience of illustration, the light deflecting parts 12 formed in the light guide plate 10A are illustrated in a quantity reduced from the actual quantity.

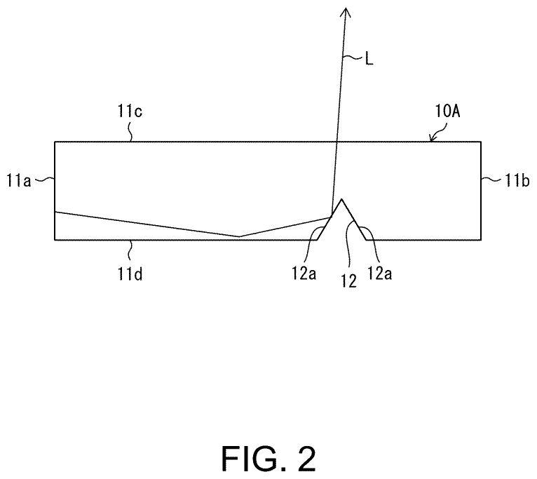

FIG. 2 is a cross-sectional view showing a path of light guided by the light guide plate 10A. As shown in FIG. 2, the light deflecting part 12 is provided at a back surface 11d of the light guide plate. The back surface 11d is another main surface, which is opposed to the exit surface 11c, of the light guide plate 10A having a rectangular cuboid shape.

The light deflecting part 12 has an inclined surface 12a as a reflecting surface that reflects the light from the light source 20 entering from the incident surface 11a toward the exit surface 11c. In this embodiment, to reflect a light L entering from the incident surface 11a, the light deflecting part 12 has an inclined surface 12a corresponding to the incident surface 11a. In the case where light also enters from the lateral surface 11b, the light guide plate 10A further includes a light deflecting part 12 having an inclined surface 12a formed corresponding to the light from the lateral surface 11b. In addition, the light deflecting part 12 may further have a surface different from the inclined surface 12a to reflect light incident on the light deflecting part 12 from a direction other than an intended direction toward a direction that cannot be recognized by an observer.

In the light guide plate 10A, the light L entering from the incident surface 11a is guided while being totally reflected between the exit surface 11c and the back surface 11d. The light L incident on the light deflecting part 12 is reflected by the inclined surface 12a and is incident on the exit surface 11c at an incident angle smaller than an incident angle at which the light L is totally reflected at the exit surface 11c. As a result, the light L exits from the exit surface 11c. However, the deflection of light by the light deflecting part 12 is not limited to resulting from reflection, and may also result from refraction, for example.

The size of the light deflecting part 12 may be, for example, 30 μm to 300 μm in a direction perpendicular to the incident direction of light from the light source 20. Further, the angle of the inclined surface 12a with respect to the back surface 11d may be, for example, 30° to 60°. The shape of the light deflecting part 12 in a plan view viewed from a direction perpendicular to the back surface 11d may be a quadrangular shape such as a rectangle, or may be a spindle shape. In particular, in the latter case, compared to the shape of the former or the like, moldability of the light deflecting part 12 is improved. However, the size and the shape of the light deflecting part 12 are not limited thereto.

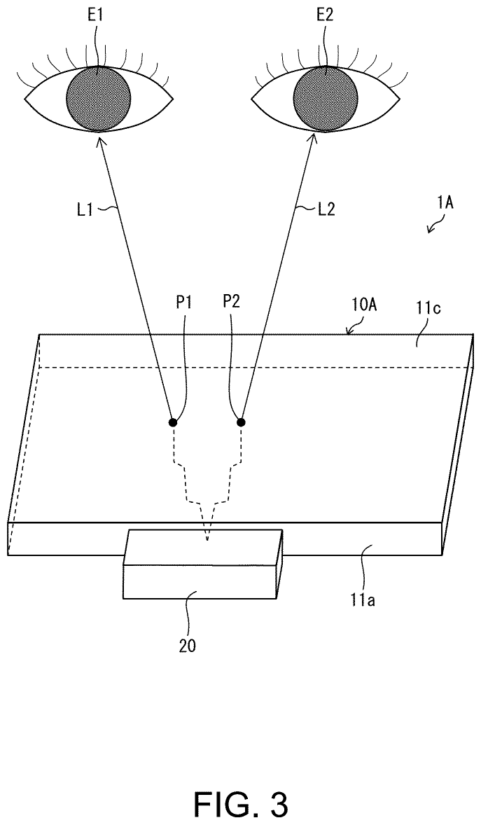

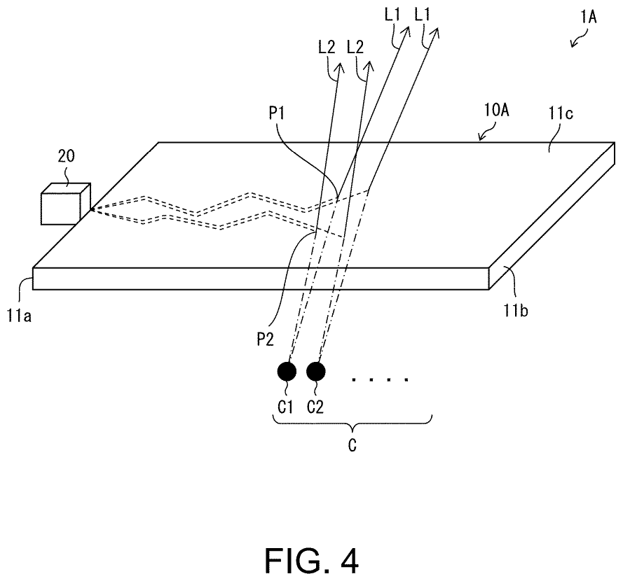

FIG. 3 is a perspective view for describing directivity of exit lights exiting from the exit surface 11c of the light guide plate 10A. FIG. 4 is a perspective view showing an intersection point at which a straight line passing through a first exit point P1 and a center of one eye E1 of an observer intersects with a straight line passing through a second exit point P2 and a center of the other eye E2 of the observer, to illustrate a principle of stereoscopic display based on parallax. For simplicity, only one light source 20 is shown in FIG. 3 and FIG. 4.

FIG. 3 shows a state in which the observer is observing the display device 1A from within an observation space of a predetermined range. The observation space refers to a space in which at least a part of the stereoscopic image SI displayed by the display device 1A is observable.

A light exiting in an angular range of irradiating to the one eye E1 of the observer and its vicinity is referred to as a first exit light L1, and a point on the exit surface 11c at which the first exit light L1 exits is referred to as a first exit point P1. Further, a light exiting in an angular range of irradiating to the other eye E2 of the same observer and its vicinity is referred to as a second exit light L2, and a point on the exit surface 11c at which the second exit light L2 exits is referred to as a second exit point P2.

The first exit light L1 exiting from the first exit point P1 is visually recognized by the one eye E1 of the observer. On the other hand, the first exit light L1 is not visually recognized by the other eye E2, or the amount of light visually recognized by the other eye E2 is very small compared to the amount of light visually recognized by the one eye E1. As a result, the first exit light L1 has directivity.

Further, the second exit light L2 from the second exit point P2 is visually recognized by the other eye E2 of the observer. On the other hand, the second exit light L2 is not visually recognized by the one eye E1, or the amount of light visually recognized by the one eye E1 is very small compared to the amount of light visually recognized by the other eye E2. As a result, the second exit light L2 has directivity.

As shown in FIG. 4, a straight line passing through the first exit point P1 and the center, i.e., the pupil/lens, of the one eye E1 and a straight line passing through the second exit point P2 and the center of the other eye E2 intersect at an intersection point C. In other words, an optical axis of the first exit light L1 visually recognized by the one eye E1 of the observer and an optical axis of the second exit light L2 visually recognized by the other eye E2 of the observer intersect at the intersection point C. Thus, the observer has an illusion that a light-emitting point appears to be present at the intersection point C.

In the case where the intersection point C is located on the observer side with respect to the exit surface 11c, it appears to the observer that the light-emitting point pops out from the exit surface 11c. On the other hand, in the case where the intersection point C is located on the opposite side of the observer with respect to the exit surface 11c, it appears to the observer that the light-emitting point is on a depth side of the exit surface 11c. In this embodiment, the intersection point C is located on the depth side of the exit surface 11c as viewed from the observer. Thus, the observer perceives a sense of depth.

In this manner, in the case where the first exit light L1 exits in an angular range directed toward the one eye E1 of the observer and its vicinity, the second exit light L2 exits in an angular range directed toward the other eye E2 of the same observer and its vicinity, and the optical axis of the first exit light L1 and the optical axis of the second exit light L2 form an intersection point C, the observer has an illusion that a light-emitting point appears to be present at the intersection point C. Thus, by forming such an intersection point C as a set of consecutive points forming a plurality of intersection points C1, C2, . . . , the observer can perceive a three-dimensional stereoscopic image SI forming, for example, a straight line.

The light source 20 is a light-emitting element that causes light to enter the light guide plate 10A. The light source 20 may be a point light source. An example of the light source 20 includes a light-emitting diode (LED). However, the light source 20 is not limited thereto and may also be another light source such as a fluorescent lamp. In FIG. 1, the display device 1A includes two light sources 20. However, the display device 1A may also include three or more light sources 20. A plurality of light sources 20 may be arranged at an interval of, for example, 10 mm, but the interval between the light sources 20 is not limited thereto.

Further, as described above, the shape of the light guide plate 10A is not limited to the rectangular cuboid shape described above. For example, the light guide plate 10A may also have a shape in which the incident surface 11a is not flush and has a step by cutting out a part of a region into a rectangular shape in a plan view viewed from a direction perpendicular to the exit surface 11c. In that case, the light source 20 may be arranged along each of the non-flush incident surfaces 11a.

The control part 30 controls turn-on and turn-off of the light source 20. Details of the control performed by the control part 30 will be described later.

### Configuration Example

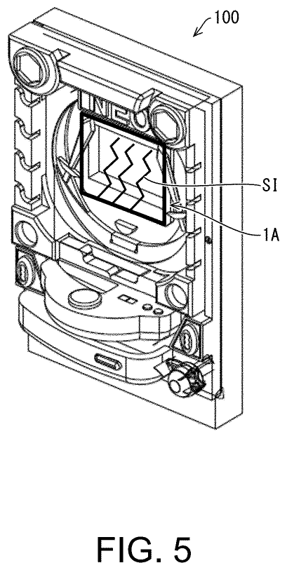

FIG. 5 is a perspective view showing a game machine 100 including the display device 1A according to this embodiment. As shown in FIG. 5, the display device 1A is provided in, for example, a pachinko machine or a pachislot machine serving as the game machine 100. The display device 1A is arranged in the vicinity of a central part of the game machine 100. The display device 1A is configured to perform an image display for various presentations, such as a presentation image indicating hitting a jackpot, a presentation image indicating an expectation degree of a jackpot, or the like. Specifically, the display device 1A is configured to stereoscopically display a stereoscopic image SI as an image display. The control part 30 performs controls such as a control on whether to display the stereoscopic image SI, a control to switch the light source 20 to be turned on at a predetermined timing, a control to perform switch of a plurality of light sources 20 emitting lights in colors different from each other at a predetermined timing, or the like.

The game machine 100 is simply an application example of the display device 1A of this embodiment and does not limit the application range of the display device 1A. The display device 1A of this embodiment may be applied to any target having a function of displaying images. Another example of the target to which the display device 1A is applied is an in-vehicle display.

As shown in FIG. 1, in the display device 1A, the light deflecting part 12 is arranged on an arrangement line 13. The arrangement line 13 is a linear arrangement region, a plurality of which are provided in the light guide plate 10A. In FIG. 1, the arrangement lines 13 are a plurality of straight lines parallel to each other. However, the shape of the arrangement line 13 is not limited thereto. Other examples of the shape of the arrangement line 13 will be described later.

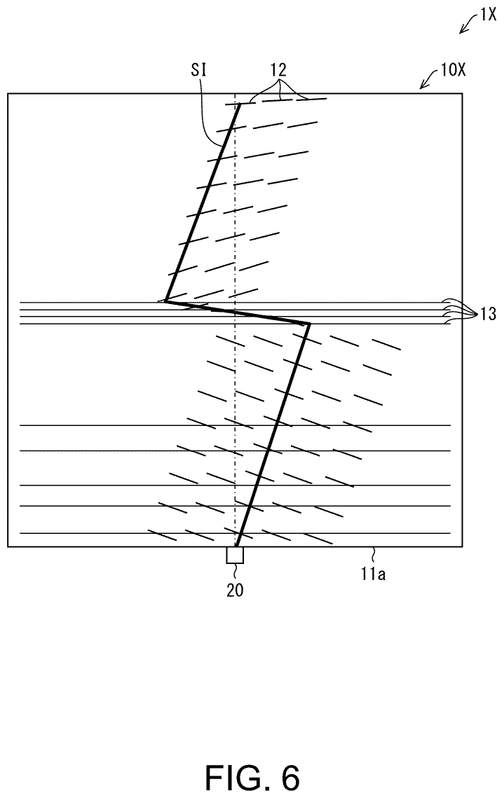

FIG. 6 is a view showing an example of the case where a stereoscopic image SI having a portion close to being parallel to the incident surface 11a is displayed in a display device 1X serving as a comparative example. The display device 1X has the same configuration as the display device 1A, except that the display device 1X includes a light guide plate 10X instead of the light guide plate 10A. The light guide plate 10X differs from the light guide plate 10A in that the arrangement line 13 is parallel to the incident surface 11a.

In FIG. 6, the stereoscopic image SI is an image of a polygonal line with two bending points. A direction of a line segment between the two bending points of the stereoscopic image SI is a direction close to being parallel to the incident surface 11a. In a region of the light guide plate 10X displaying such a line segment, it is necessary to narrow the interval between the arrangement lines 13. Thus, the density of the light deflecting parts 12 in this region becomes high, and transparency of the light guide plate 10X may decrease. Further, as described later, in the display device 1X including the light guide plate 10X, it may become difficult to display the line segment close to being parallel to the incident surface 11a as a continuous line image.

In the light guide plate 10A, the arrangement lines 13 are not parallel to the incident surface 11a. Thus, in the light guide plate 10A, even in a region displaying a stereoscopic image close to being parallel to the incident surface 11a, the interval between the arrangement lines 13 can be widened and the density of the light deflecting parts 12 can be reduced. Thus, compared to the case where the arrangement lines 13 are parallel to the incident surface 11a, a light guide plate 10A having a high transparency can be realized.

Furthermore, with the arrangement lines 13 not being parallel to the incident surface 11a, the light guide plate 10A can improve visibility of a portion, which is parallel to the incident surface 11a, of the stereoscopic image SI displayed by the light deflecting parts 12 arranged according to this region.

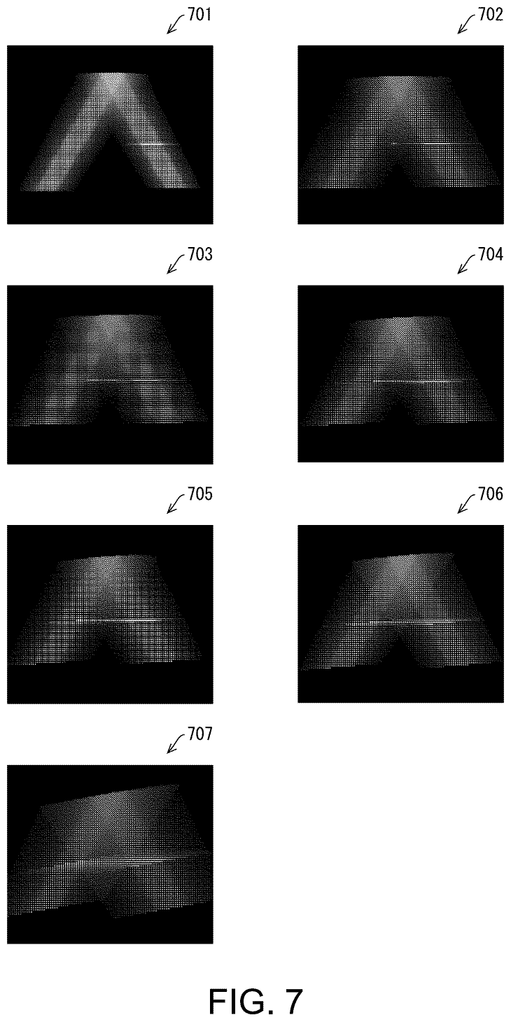

FIG. 7 is a view showing examples of a relationship between an angle formed between the arrangement lines 13 and the incident surface 11a and a display of the stereoscopic image SI in the display device 1A. In the examples of FIG. 7, an image of a character “A” is displayed as the stereoscopic image SI. In FIG. 7, a reference sign 701 indicates a case where the angle formed between the arrangement lines 13 and the incident surface 11a is 0°. A reference sign 702 indicates a case where the angle formed between the arrangement lines 13 and the incident surface 11a is 1°. A reference sign 703 indicates a case where the angle formed between the arrangement lines 13 and the incident surface 11a is 2°. A reference sign 704 indicates a case where the angle formed between the arrangement lines 13 and the incident surface 11a is 3°. A reference sign 705 indicates a case where the angle formed between the arrangement lines 13 and the incident surface 11a is 4°. A reference sign 706 indicates a case where the angle formed between the arrangement lines 13 and the incident surface 11a is 5°. A reference sign 707 indicates a case where the angle formed between the arrangement lines 13 and the incident surface 11a is 10°.

The image of the character “A” includes two oblique line images and one horizontal line image. Specifically, the horizontal line image is an image parallel to the incident surface 11a. As indicated by the reference sign 701, in the case where the angle formed between the arrangement lines 13 and the incident surface 11a is 0°, the horizontal line image can hardly be visually recognized. As indicated by the reference sign 702, in the case where the angle formed between the arrangement lines 13 and the incident surface 11a is 1°, the horizontal line image can be faintly visually recognized. From the reference sign 703 onward, as the angle formed between the arrangement lines 13 and the incident surface 11a increases, visibility of the horizontal line image improves.

In the light guide plate 10A, not all regions of all the arrangement lines 13 have to be regions that are not parallel to the incident surface 11a. In the display device 1A, it is possible that at least one arrangement line 13 includes a region that is not parallel to the incident surface 11a. Particularly, a region involved in the display of a portion of the stereoscopic image SI that is close to being parallel to the incident surface 11a or is parallel to the incident surface 11a may be a region that is not parallel to the incident surface 11a. With the arrangement line 13 including a region that is not parallel to the incident surface 11a as described above, the transparency of the light guide plate 10A and the visibility of the portion of the stereoscopic image SI parallel to the incident surface 11a can be improved.

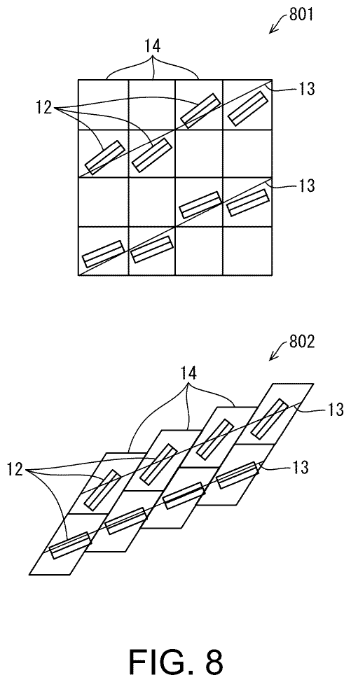

FIG. 8 is a view showing specific examples of an arrangement of the light deflecting parts 12 in the light guide plate 10A. In FIG. 8, a reference sign 801 and a reference sign 802 indicate specific examples different from each other. In each of the specific examples, a matrix 14 is defined for a region in which the light deflecting parts 12 are arranged, and the light deflecting parts 12 are arranged within the matrix 14.

In the example indicated by the reference sign 801, the matrix 14 is arranged along a direction parallel to the incident surface 11a and a direction perpendicular to the incident surface 11a. In that case, by arranging the light deflecting parts 12 only in the matrix 14 located on the arrangement lines 13, the light deflecting parts 12 can be arranged along the arrangement lines 13.

In the example indicated by the reference sign 802, the matrix 14 is arranged in a direction along the arrangement lines 13. In that case, by arranging the light deflecting parts 12 in any matrix 14, the light deflecting parts 12 can be arranged along the arrangement lines 13.

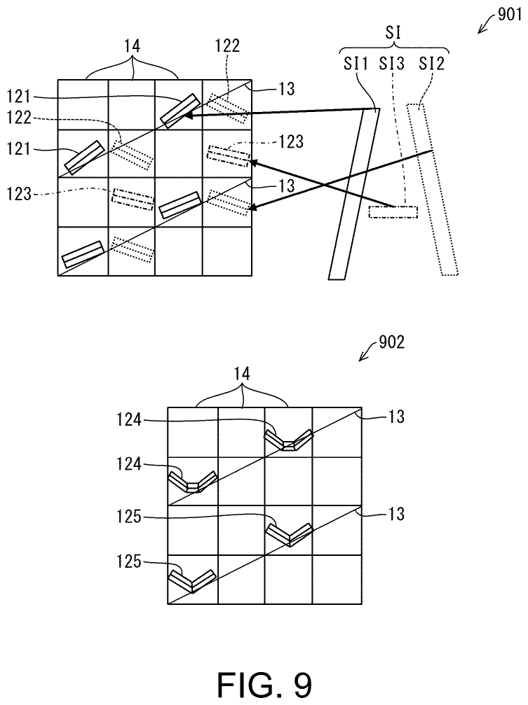

FIG. 9 is a view showing more specific examples of the arrangement of the light deflecting parts 12 in the light guide plate 10A. In FIG. 9, a reference sign 901 and a reference sign 902 indicate examples different from each other. FIG. 9 shows examples of the case of displaying an image of the character “A”. In FIG. 9, the stereoscopic image SI, which is an image of the character “A”, is divided into two oblique line images SI1 and SI2 and one horizontal line image SI3.

As the light deflecting parts 12, the example indicated by the reference sign 901 shows light deflecting parts 121 for displaying the oblique line image SI1, light deflecting parts 122 for displaying the oblique line image SI2, and light deflecting parts 123 for displaying the horizontal line image SI3. The light deflecting parts 121 and the light deflecting parts 122 may be respectively arranged in matrices 14 different from each other on the arrangement lines 13.

Further, the light deflecting parts 123 may be arranged parallel to the arrangement lines 13 in another different matrix 14.

Further, the light deflecting part 12 may display two or more of the oblique line images SI1 and SI2 and the horizontal line image SI3. As the light deflecting parts 12, the example indicated by the reference sign 902 shows light deflecting parts 124 for displaying the oblique line images SI1 and SI2 and the horizontal line image SI3, and light deflecting parts 125 for displaying the oblique line images SI1 and SI2. The light deflecting parts 124 and the light deflecting parts 125 may be respectively arranged in matrices 14 different from each other on the arrangement lines 13.

In the case of displaying a plurality of images with the light deflecting part 12, the light deflecting part 12 includes portions corresponding to the respective images. In that case, the light deflecting part 12 may be formed such that portions convex with respect to the incident direction of light are more than concave portions. In that case, compared to the case where portions concave with respect to the incident direction of light are more than convex portions, stray light resulting from multiple-time reflections of light by the light deflecting part 12 can be reduced.

In the display device 1A, the control part 30 may switch the position of the light source 20 that causes light to enter the light guide plate 10A among the plurality of light sources 20. For example, the control part 30 may sequentially turn on and turn off the plurality of light sources 20. Accordingly, it is possible to create a presentation in which the stereoscopic image SI appears to be moving. At this time, the stereoscopic image SI moves in a direction along the arrangement lines 13.

In the example indicated by the reference sign 801, a pitch of the matrix 14 is equal in a direction parallel to the incident surface 11a and a direction perpendicular to the incident surface 11a. In that case, an angle formed between each of the arrangement lines 13 and the incident surface 11a may be 2.5° or more. Further, an angle formed between each of the arrangement lines 13 and the incident surface 11a may be 5° or more. Accordingly, the visibility of the portion of the stereoscopic image SI that is parallel to the incident surface 11a becomes sufficiently high.

Further, the display device 1A may include a plurality of light guide plates 10A overlapped such that their main surfaces are parallel to each other. In that case, in a region in which the arrangement lines 13 are parallel to the incident surface 11a, interference fringes may occur due to the light deflecting parts 12 arranged along the arrangement lines 13. In the case where the display device 1A includes a plurality of light guide plates 10A, occurrence of interference fringes can be reduced by configuring the slopes of the arrangement lines 13 in each of the light guide plates 10A to be different from each other.

Further, the display device 1A may be used by overlapping with a flat display such as a liquid crystal display. In that case, a display system can be configured to be capable of simultaneously providing a display by the flat display and a stereoscopic image display by the display device 1A. In such a display system, occurrence of interference fringes can be reduced by configuring an arrangement direction of the pixels of the flat display and the slope of the arrangement lines 13 to be different from each other.

Further, the pitch of the matrix 14 may be changed as appropriate depending on the purpose. For example, to cause the stereoscopic image SI to smoothly move in a direction parallel to the incident surface 11a, the pitch of the matrix 14 in this direction may be reduced to increase resolution. Further, to improve visibility of a portion of the stereoscopic image SI that is parallel to the incident surface 11a, the pitch of matrix 14 in a direction perpendicular to the incident surface 11a may be reduced to increase resolution.

Further, the light source 20 may be a so-called RGB LED capable of adjusting light color. In that case, the control part 30 may control the color of light emitted by the light source 20. The control part 30 can realize an effective presentation by, for example, configuring the colors of lights of the light sources 20 adjacent to each other to be different from each other.

Further, the control part 30 can realize a more impactful presentation based on color mixture by superimposing a plurality of stereoscopic images of colors different from each other. For example, by superimposing a stereoscopic image of (R, G, B)=(255, 0, 0) and a stereoscopic image of (R, G, B)=(0, 255, 255), the overlapping portion can be configured to be (R, G, B)=(255, 255, 255), i.e., white. Further, the control part 30 may also superimpose three or more stereoscopic images.

In the light guide plate 10A, depending on the position of the stereoscopic image SI to which an arrangement line 13 corresponds, the quantity of the light deflecting parts 12 arranged on this arrangement line 13 varies. For example, in the case of displaying an image of the character “A” as the stereoscopic image SI, the light deflecting parts 12 for displaying the two oblique line images are arranged on the arrangement lines 13 corresponding to an upper part and a lower part of the stereoscopic image SI. On the other hand, the light deflecting parts 12 for displaying the two oblique line images and the horizontal line image are arranged on the arrangement lines 13 corresponding to the vicinity of the central part of the stereoscopic image SI. Thus, since the quantity of the light deflecting parts 12 arranged on the arrangement lines 13 varies depending on the shape of the stereoscopic image SI, the density of the light deflecting parts 12 varies depending on the position in the light guide plate 10A.

In the case where the shape of the light deflecting parts 12 is constant, variations may occur in the transparency of the light guide plate 10A due to the density of the light deflecting parts 12. To reduce such variations, the shape or the like of the light deflecting parts 12 may be changed as appropriate. Alternatively, dummy light deflecting parts 12 unrelated to the display of the stereoscopic image SI may be arranged in regions in which the density of the light deflecting parts 12 is small.

### Embodiment 2

Other embodiments of the disclosure will be described below. For convenience of description, members having the same functions as the members described in the above embodiment will be labeled with the same reference signs, and descriptions thereof will not be repeated.

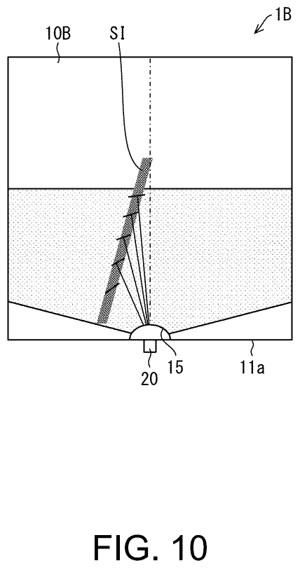

FIG. 10 is a plan view showing an example of a display device 1B according to Embodiment 2. The display device 1B differs from the display device 1A in that the display device 1B includes a light guide plate 10B instead of the light guide plate 10A. A light input part 15 is provided in the vicinity of the light source 20 in the incident surface 11a of the light guide plate 10B. The light input part 15 is a portion at which the incident surface 11a is formed into a concave shape.

In the light guide plate 10A without the light input part 15, a spread of the light entering from the incident surface 11a is at most about 40° with respect to the optical axis, depending on the material of the light guide plate 10A. Thus, it is difficult to display, in the vicinity of the light source 20, a stereoscopic image SI that is large in a direction perpendicular to the optical axis. For example, in the case where the stereoscopic image SI has a size of 20 mm in a direction perpendicular to the optical axis, it is necessary to separate the arrangement position of the light deflecting parts 12 by 10 mm or more away from the light source 20 in a direction along the optical axis. However, the position at which the light deflecting part 12 is actually arranged is also influenced by conditions such as the shape of the stereoscopic image SI.

In the display device 1B, the light from the light source 20 enters into the light guide plate 10B from the light input part 15. Thus, in the display device 1B, a spread of light, which enters from the light input part 15, in a plane parallel to the main surface of the light guide plate 10B becomes larger than the spread of light entering from the flat incident surface 11a into the light guide plate 10A in the display device 1A. That is, in the light guide plate 10B, a region to which light is capable of reaching in the vicinity of the incident surface 11a becomes wider than a region to which light is capable of reaching in the vicinity of the incident surface 11a of the light guide plate 10A. Thus, a degree of freedom in designing the light guide plate 10B is improved.

In addition to the portion in a concave shape as described above, the light input part 15 may also be a slit, a lens array, a diffusion member, or the like arranged between the light source 20 and the incident surface 11a. An example of the diffusion member includes frosted glass.

Further, as in another embodiment to be described later, light may also be caused to enter the light guide plate 10B from another lateral surface adjacent to the incident surface 11a in the display device 1B. However, in that case, unintended light emission (crosstalk) may occur due to incidence of light from the another lateral surface onto the light deflecting parts 12 which are located in the vicinity of the light input part 15 and have a large inclination with respect to the incident surface 11a. Thus, the shape, size, etc. of the light deflecting parts 12 located in the vicinity of the light input part 15 may be adjusted as appropriate to reduce crosstalk.

### Embodiment 3

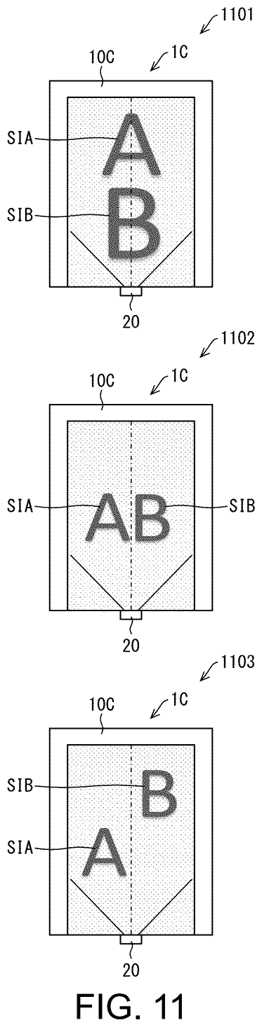

FIG. 11 is a plan view showing an example of a display device 1C according to Embodiment 3. In FIG. 11, reference signs 1101, 1102, and 1103 indicate examples of the display device 1C different from each other. In the examples shown in FIG. 11, the display device 1C differs from the display device 1A in that the display device 1C includes a light guide plate 10C instead of the light guide plate 10A. The light guide plate 10C is capable of displaying a plurality of stereoscopic images SIA and SIB by the light entering from the light source 20. In FIG. 11, the stereoscopic image SIA is an image of the character “A”, and the stereoscopic image SIB is an image of a character “B”. In FIG. 11, the display device 1C displays the stereoscopic images SIA and SIB based on the light from the same light source 20.

As indicated by the reference sign 1101, the stereoscopic images SIA and SIB may be adjacent to each other in a direction along the incident direction of light. Further, as indicated by the reference sign 1102, the stereoscopic images SIA and SIB may also be adjacent to each other in a direction perpendicular to the incident direction of light. Further, as indicated by the reference sign 1103, the stereoscopic images SIA and SIB may also be adjacent to each other in a direction different from both the incident direction of light and a direction perpendicular thereto.

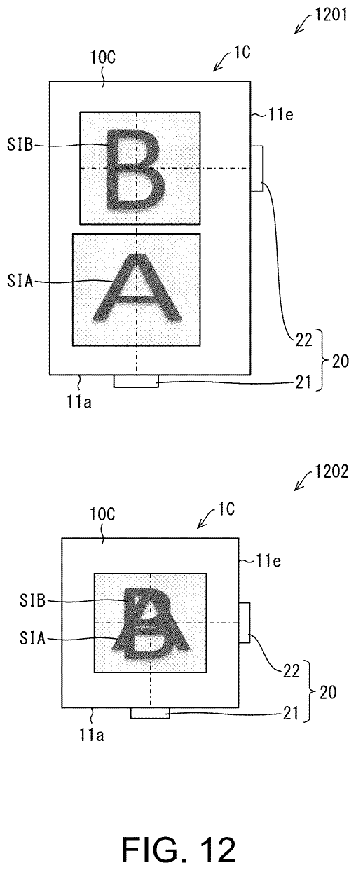

FIG. 12 is a plan view showing another example of the display device 1C. In FIG. 12, reference signs 1201 and 1202 indicate examples of the display device 1C different from each other. In the examples shown in FIG. 12, as the light source 20, the display device 1C includes a light source 21 that causes light to enter from the incident surface 11a, and a light source 22 that causes light to enter from another lateral surface 11e adjacent to the incident surface 11a. In the display device 1C, the stereoscopic image SIA is displayed based on the light from the light source 21, and the stereoscopic image SIB is displayed based on the light from the light source 22.

As indicated by the reference sign 1201, the light deflecting parts 12 for displaying the stereoscopic image SIA and the light deflecting parts 12 for displaying the stereoscopic image SIB may be arranged in regions separate from each other. Further, as indicated by the reference sign 1202, the light deflecting parts 12 for displaying the stereoscopic image SIA and the light deflecting parts 12 for displaying the stereoscopic image SIB may be arranged in the same region as each other. In particular, in the example indicated by the reference sign 1202, it is possible to switch which of the stereoscopic image SIA and the stereoscopic image SIB is to be displayed by the display device 1C by switching which of the light source 21 and the light source 22 is to be turned on.

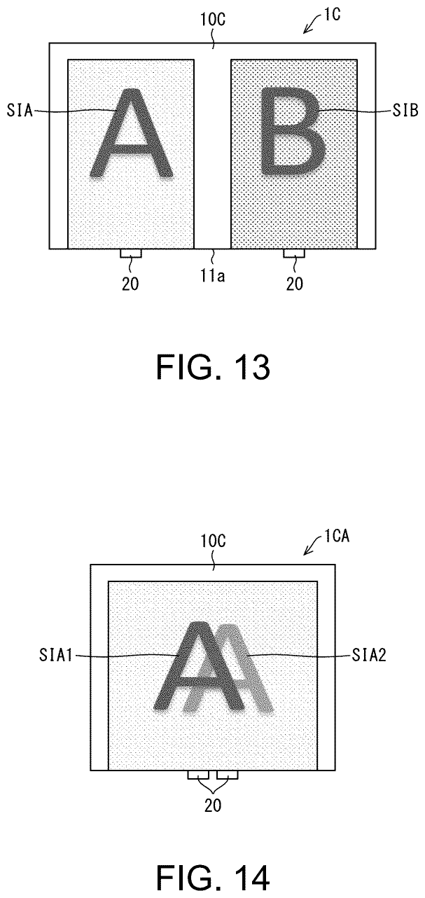

FIG. 13 is a plan view showing still another example of the display device 1C. In the example shown in FIG. 13, the display device 1C displays a plurality of stereoscopic images SIA and SIB based on light entering from the incident surface 11a of the light guide plate 10C. In the example shown in FIG. 13, a light source 20 for displaying the stereoscopic image SIA and a light source 20 for displaying the stereoscopic image SIB are provided separately from each other.

In the example shown in FIG. 13, the display device 1C has a structure that narrows the spread of light entering the light guide plate 10C. For example, a convex lens (not shown) may be arranged between the light source 20 and the light guide plate 10C. Alternatively, the light source 20 may also be a highly directional light source such as a bullet LED. Alternatively, the incident surface 11a may also have a shape that narrows the spread of entering light. Accordingly, in the case where the display device 1C displays only one of the stereoscopic images SIA and SIB, unintended display of the other is reduced.

Further, in the display device 1C, the stereoscopic images SIA and SIB are displayed by the light deflecting parts 12 in partial regions of the light guide plate 10C different from each other. In other words, the stereoscopic images displayed by the display device 1C include a stereoscopic image SIA (first stereoscopic image) displayed by the light deflecting parts 12 in a first partial region, which is a part of a region of the light guide plate 10C, and a stereoscopic image SIB (second stereoscopic image) displayed by the light deflecting parts 12 in a second partial region, which is a region different from the first partial region in the light guide plate 10C.

In such a display device 1C, the light deflecting parts 12 may be provided such that the stereoscopic image SIA and the stereoscopic image SIB are observable from within the same observation space. In that case, the observer can observe the first stereoscopic image SIA and the second stereoscopic image SIB from within the same observation space.

By configuring the observation space in which the first stereoscopic image SIA and the second stereoscopic image SIB are observable into a relatively narrow limited space, a display can be configured such that the first stereoscopic image SIA and the second stereoscopic image SIB are observable only from this limited space. On the other hand, by configuring the observation space in which the first stereoscopic image SIA and the second stereoscopic image SIB are observable into a relatively large wide-area space, a display can be configured such that the first stereoscopic image SIA and the second stereoscopic image SIB are observable from a wide range. This wide-area space may also include a position at which the distance from the light guide plate 10C becomes infinity.

Further, in the display device 1C, the light deflecting parts 12 may also be provided such that an observation space in which the stereoscopic image SIA is observable and an observation space in which the stereoscopic image SIB is observable are arranged at positions different from each other. In that case, in the case where the observer observes one of the stereoscopic image SIA and the stereoscopic image SIB, reflection of the other can be reduced.

### Modification Example 1

FIG. 14 is a view showing a display device 1CA according to a first modification example of Embodiment 3. In the example shown in FIG. 14, a distance between the light sources 20 is smaller than in other embodiments. Further, the display device 1CA displays a plurality of stereoscopic images SIA1 and SIA2. The stereoscopic images SIA1 and SIA2 are images of the character “A” in shapes capable of being regarded as identical to each other.

In this state, by adjusting the brightness of each of the light sources 20 as appropriate, it becomes possible to create a presentation in which one of the plurality of stereoscopic images SIA1 and SIA2 appears to be a shadow of the other. Accordingly, the observer can be caused to feel a sense of front-rear perspective.

### Modification Example 2

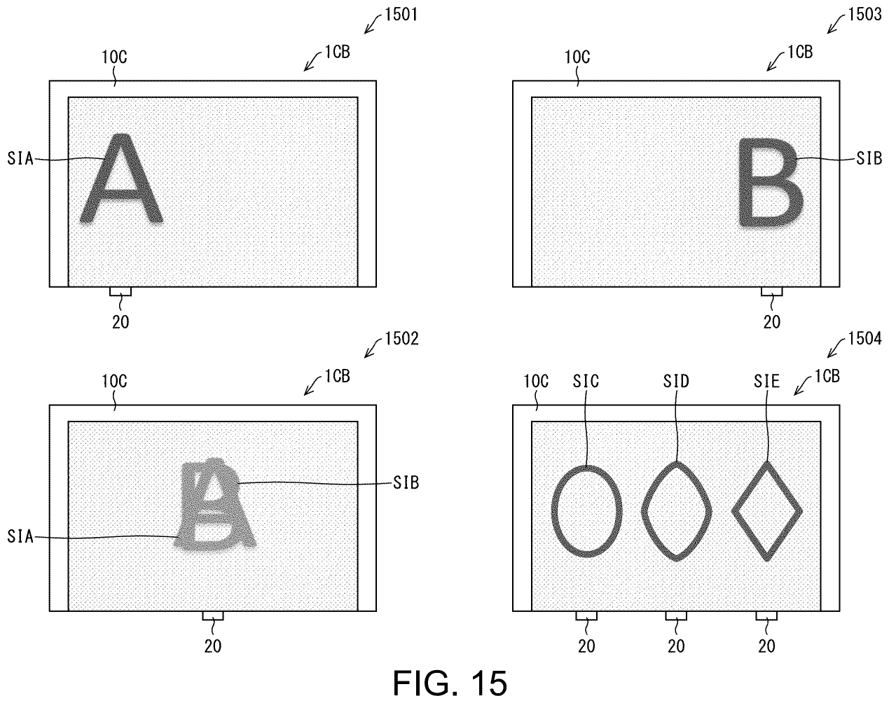

FIG. 15 is a view showing a display device 1CB according to a second modification example of Embodiment 3. In the examples indicated by reference signs 1501, 1502, and 1503 in FIG. 15, the display device 1CB performs a presentation called a dissolve, in which a plurality of stereoscopic images SIA and SIB appear to switch while moving. In other words, the control part 30 switches the position of the light source 20 to be turned on to cause the display positions of the stereoscopic images SIA and SIB to move. For simplicity, in FIG. 15, illustration of the light sources 20 that are not on is omitted. In FIG. 15, the reference sign 1501 indicates a display when movement of the display position starts, the reference sign 1502 indicates a display during movement of the display position, and the reference sign 1503 indicates a display when movement of the display position ends.

However, the display positions of the stereoscopic images SIA and SIB during movement of the display positions are not limited to the example indicated by the reference sign 1502. The display device 1CB may also display the stereoscopic images SIA and SIB at display positions other than those indicated by the reference sign 1502 during movement of the display positions. Further, during movement of the display positions, it is also possible that the display device 1CB does not display the stereoscopic images SIA and SIB at the display positions indicated by the reference sign 1502.

As indicated by the reference sign 1501, when movement of the display position starts, only the stereoscopic image SIA is displayed. As indicated by the reference sign 1502, during movement of the display position, the stereoscopic images SIA and SIB are displayed overlapped with each other. At this time, the size, the inclination angle, the density, etc. of the light deflecting parts 12 are adjusted such that the image mainly visually recognized changes from the stereoscopic image SIA to the stereoscopic image SIB as the movement of the display position progresses. As indicated by the reference sign 1503, when movement of the display position ends, only the stereoscopic image SIB is displayed. According to the display device 1CB, it becomes possible to create an impactful presentation in which the display position of the stereoscopic image appears to gradually change from the stereoscopic image SIA to the stereoscopic image SIB while moving.

Further, in FIG. 15, a reference sign 1504 indicates a view showing another example of the display device 1CB according to the second modification example of Embodiment 3 different from the reference signs 1501 to 1503. In the example indicated by the reference sign 1504 in FIG. 15, the display device 1CB sequentially displays three types of stereoscopic images SIC, SID, and SIE respectively at positions different from each other. For simplicity, in the reference sign 1504, the stereoscopic images SIC, SID, and SIE are shown in one view.

In the example indicated by the reference sign 1504 in FIG. 15, the stereoscopic image SIC is an image of an elliptical pattern. The stereoscopic image SIE is an image of a rhombus pattern. The stereoscopic image SID is an image of a pattern that is intermediate between an ellipse and a rhombus. In this example, the display device 1CB performs a presentation called a morphing, in which the stereoscopic image SIC appears to sequentially transform into the stereoscopic images SID and SIE while moving.

### Modification Example 3

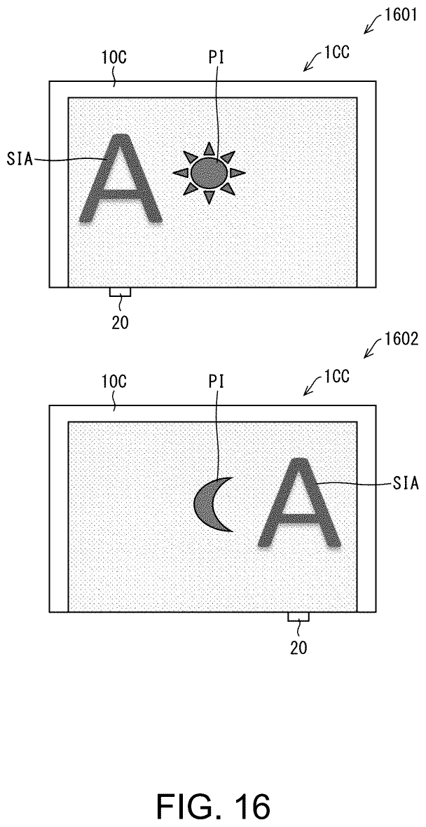

FIG. 16 is a view showing a display device 1CC according to a third modification example of Embodiment 3. In the example shown in FIG. 16, the display device 1CC displays a stereoscopic image SIA and a planar image PI. In FIG. 16, a reference sign 1601 and a reference signs 1602 indicate the display device 1CC in states in which the light sources 20 being turned on are different from each other. For simplicity, in FIG. 16, illustration of the light source 20 that is not on is omitted.

As indicated by the reference sign 1601 and the reference sign 1602 in FIG. 16, the display position of the stereoscopic image SIA moves by switching the position of the light source 20 being turned on. On the other hand, the planar image PI is displayed at a constant position on the exit surface 11c or the back surface 11d, regardless of the position of the light source 20 being turned on. In the example of FIG. 16, a display content of the planar image PI is switched depending on the position of the light source 20 being turned on. However, the display content of the planar image PI may also be always constant regardless of the position of the light source 20 being turned on.

Thus, in the display device 1CC, it becomes possible to create a more impactful presentation by combining the stereoscopic image SIA and the planar image PI. Further, with the observer referring to the planar image PI displayed on the exit surface 11c or on the back surface 11d, a sense of depth in the stereoscopic image SIA displayed on the depth side of the light guide plate 10C is more emphasized.

### Modification Example 4

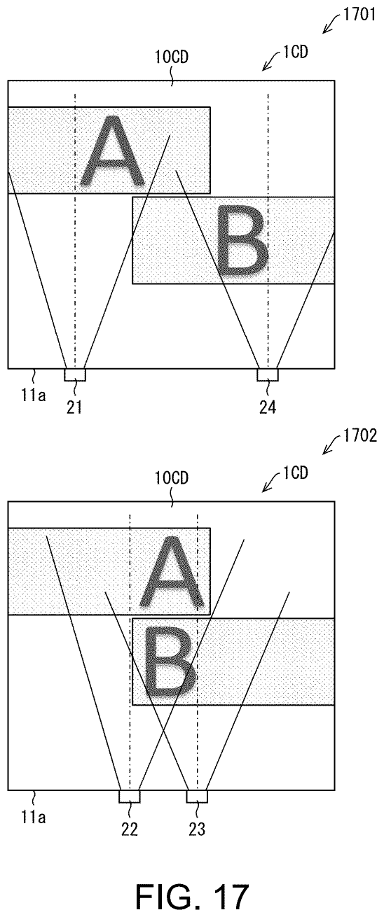

FIG. 17 is a view showing a display device 1CD according to a fourth modification example of Embodiment 3. In FIG. 17, a reference sign 1701 and a reference sign 1702 indicate the display device 1CD in states in which the light sources 20 being turned on are different from each other. For simplicity, in FIG. 17, illustration of the light sources 20 that are not on is omitted.

The display device 1CD includes a light guide plate 10CD, and light sources 21, 22, 23, and 24 as the light source 20. The light guide plate 10CD displays stereoscopic images SIA and SIB. The light sources 21, 22, 23, and 24 are sequentially arranged along the incident surface 11a of the light guide plate 10CD. The light sources 21 and 22 cause light for displaying the stereoscopic image SIA to enter the light guide plate 10CD. The light sources 23 and 24 cause light for displaying the stereoscopic image SIB to enter the light guide plate 10CD. For simplicity, in FIG. 17, illustration of the light sources 20 that are not on is omitted.

In the display device 1CD, the display position of the stereoscopic image SIA in a direction along the incident surface 11a is shifted to the light source 23 and 24 side of the optical axis of each of the light sources 21 and 22. Further, in the display device 1CD, the display position of the stereoscopic image SIB is shifted to the light source 21 and 22 side of the optical axis of each of the light sources 23 and 24. In particular, the display positions of the stereoscopic image SIA displayed by the light source 22 and the stereoscopic image SIB displayed by the light source 23 in a direction along the incident surface 11a may be regarded as substantially identical. Further, the display position of the stereoscopic image SIA in a direction perpendicular to the incident surface 11a is separated more away from the incident surface 11a than the display position of the stereoscopic image SIB in this direction.

In the display device 1CD, the control part 30 may first turn on the light sources 21 and 24, and then turn on the light sources 22 and 23. Accordingly, it becomes possible to create a presentation in which the stereoscopic images SIA and SIB appear to converge in the vicinity of the center of the light guide plate 10CD. Further, at this time, the stereoscopic images SIA and SIB can be displayed in colors different from each other by configuring the lights emitted by the light sources 22 and 23 to be colors different from each other.

### Embodiment 4

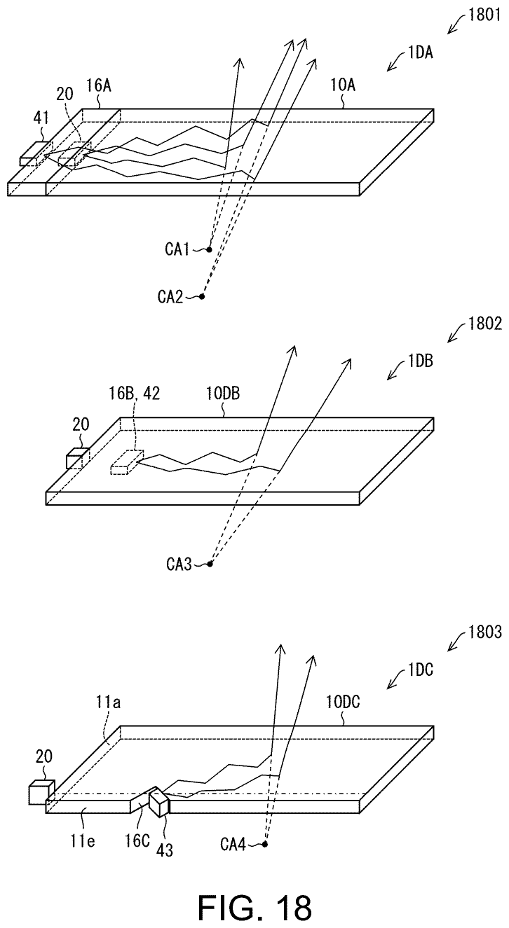

FIG. 18 is a view showing display devices 1DA, 1DB, and 1DC according to Embodiment 4. In FIG. 18, a reference sign 1801 indicates a perspective view showing an outline of the display device 1DA, a reference sign 1802 indicates a perspective view showing an outline of the display device 1DB, and a reference sign 1803 indicates a perspective view showing an outline of the display device 1DC.

As indicated by the reference sign 1801, the display device 1DA includes an auxiliary light guide body 16A in addition to the configuration of the display device 1A. The auxiliary light guide body 16A may have the same configuration as the light guide plate 10A except for not including the light deflecting part 12.

Further, the display device 1DA further includes a light source 41, which is a light source different from the light source 20. The light emitted from the light source 41 enters the light guide plate 10A via the auxiliary light guide body 16A and exits from the exit surface 11c. A distance of the light from the light source 41 until exiting from the exit surface 11c becomes longer by an amount of the auxiliary light guide body 16A compared to a distance of the light from the light source 20 until exiting from the exit surface 11c. Thus, an intersection point CA1 for the light from the light source 20 and an intersection point CA2 for the light from the light source 41 are formed in the display device 1DA. A depth amount with respect to the light guide plate 10A, i.e., a distance as viewed from the light guide plate 10A, is different between the intersection point CA1 and the intersection point CA2.

As indicated by the reference sign 1802, the display device 1DB differs from the display device 1A in that the display device 1DB includes a light guide plate 10DB instead of the light guide plate 10A. The light guide plate 10DB differs from the light guide plate 10A in that the light guide plate 10DB has a recess 16B. The recess 16B is a recess formed on the back surface 11d of the light guide plate 10DB.

In addition, the display device 1DB further includes a light source 42, which is a light source different from the light source 20. In the reference sign 1802, illustration of the light source 20 is omitted. The light source 42 is accommodated in the recess 16B. A distance of the light from the light source 42 until exiting from the exit surface 11c becomes shorter by a distance between the incident surface 11a and the recess 16B compared to a distance of the light from the light source 20 until exiting from the exit surface 11c. Thus, an intersection point CA1 (see the reference sign 1801) for the light from the light source 20 and an intersection point CA3 for the light from the light source 42 are formed in the display device 1DB. A depth amount with respect to the light guide plate 10DB is different between the intersection point CA1 and the intersection point CA3.

As indicated by the reference sign 1803, the display device 1DC differs from the display device 1A in that the display device 1DC includes a light guide plate 10DC instead of the light guide plate 10A. The light guide plate 10DC differs from the light guide plate 10A in that an intermediate light input part 16C is formed. The intermediate light input part 16C is a portion that is provided on the lateral surface 11e of the light guide plate 10DC adjacent to the incident surface 11a and causes light to enter the light guide plate 10DC.

In addition, the display device 1DC further includes a light source 43, which is a light source different from the light source 20. The light source 43 causes light to enter the light guide plate 10DC from the intermediate light input part 16C. Furthermore, the light source 20 in the display device 1DC is arranged in the vicinity of the lateral surface 11e such that the optical axis of the light from the light source 20 passes through the light source 43. A distance of the light from the light source 43 until exiting from the exit surface 11c becomes shorter by a distance between the incident surface 11a and the intermediate light input part 16C compared to a distance of the light from the light source 20 until exiting from the exit surface 11c. Thus, an intersection point CA1 (see the reference sign 1801) for the light from the light source 20 and an intersection point CA4 for the light from the light source 43 are formed in the display device 1DC. A depth amount with respect to the light guide plate 10DC is different between the intersection point CA1 and the intersection point CA4.

As described above, in each of the display devices 1DA, 1DB, and 1DC, a plurality of intersection points with depth amounts different from each other are formed for each arrangement line 13. Thus, each of the display devices 1DA, 1DB, and 1DC can display, as a whole, a plurality of stereoscopic images with depth amounts different from each other.

### Modification Example

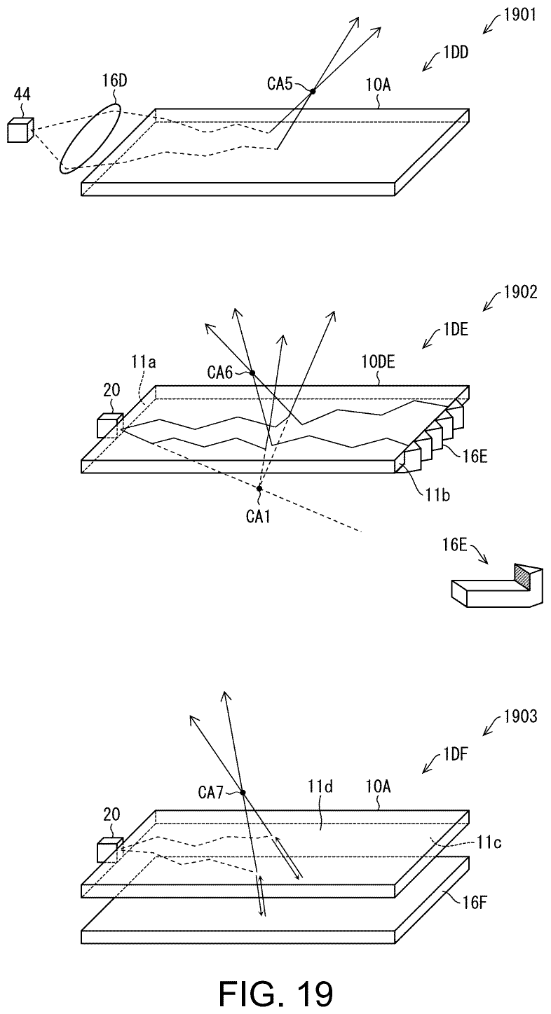

FIG. 19 is a view showing display devices 1DD, 1DE, and 1DF according to a modification example of Embodiment 4. In FIG. 19, a reference sign 1901 indicates a perspective view showing an outline of the display device 1DD, a reference sign 1902 indicates a perspective view showing an outline of the display device 1DE, and a reference sign 1903 indicates a perspective view showing an outline of the display device 1DF.

As indicated by the reference sign 1901, the display device 1DD includes a lens 16D and a light source 44 that causes light to enter the light guide plate 10A via the lens 16D, in addition to the configuration of the display device 1A. Further, although not shown in the reference sign 1901, the display device 1DD also includes the light source 20. An intersection point CA1 (see the reference sign 1801) for the light from the light source 20 and an intersection point CA5 for the light from the light source 44 are formed in such a display device 1DD.

A depth amount with respect to the light guide plate 10DC is different between the intersection point CA1 and the intersection point CA5. Depending on the properties of the lens 16D, the intersection point CA5 may be formed on the observer side of the light guide plate 10A, as indicated by the reference sign 1901. With such a display device 1DD, a plurality of stereoscopic images with depth amounts different from each other can also be displayed.

As indicated by the reference sign 1902, the display device 1DE differs from the display device 1A in that the display device 1DE includes a light guide plate 10DE instead of the light guide plate 10A. The light guide plate 10DE differs from the light guide plate 10A in that a recursive reflection structure 16E is formed on the lateral surface 11b, which is a lateral surface opposed to the incident surface 11a.

The recursive reflection structure 16E reflects light incident on the lateral surface 11b to a direction capable of being regarded as substantially identical to the incident direction. However, instead of including the light guide plate 10DE, the display device 1DE may also include a structure in which a separate recursive reflection member having the same function as the recursive reflection structure 16E is attached to the lateral surface 11b of the light guide plate 10A.

In the display device 1DE, an intersection point CA6 different from the intersection point CA1 is formed by the light reflected on the lateral surface 11b. Depending on the shape of the light deflecting parts 12, the intersection point CA6 may be located on the observer side of the light guide plate 10DE, as indicated by the reference sign 1902. With such a display device 1DE, a plurality of stereoscopic images with depth amounts different from each other can also be displayed.

As indicated by the reference sign 1903, the display device 1DF includes a recursive reflection plate 16F in addition to the configuration of the display device 1A. The recursive reflection plate 16F reflects incident light to a direction capable of being regarded as substantially the same as the incident direction. The recursive reflection plate 16F is arranged on the exit surface 11c side of the light guide plate 10A. Considering visibility, in the reference sign 1903, the positional relationship between the exit surface 11c and the back surface 11d is reversed from other figures.

In this modification example, the observer observes the display device 1DF from the back surface 11d side. The light reflected by the recursive reflection plate 16F forms an intersection point CA7 on the observer side of the light guide plate 10A. Thus, according to the display device 1DF, using the light guide plate 10A, a stereoscopic image can be displayed at a position closer to the observer side than the light guide plate 10A. That is, the observer can observe a stereoscopic image that pops out toward the observer from the light guide plate 10A.

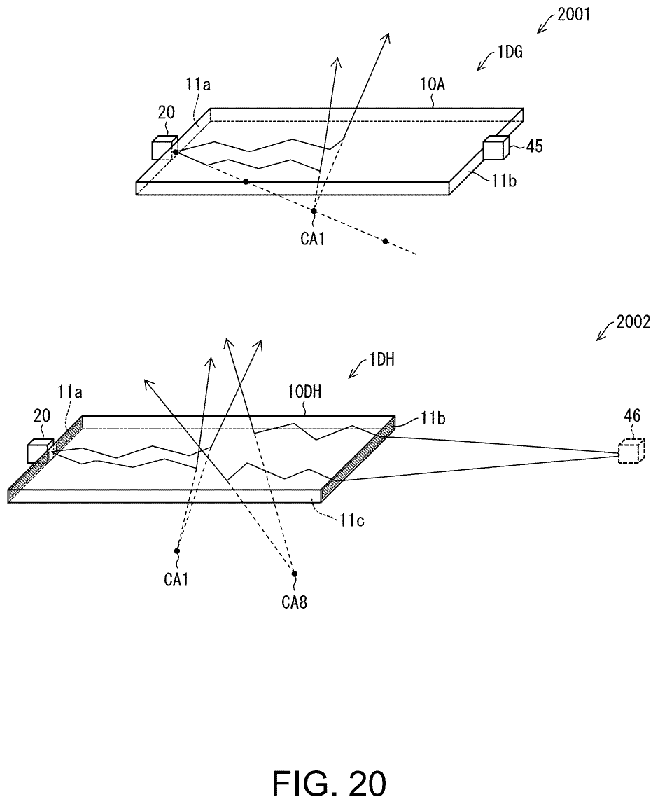

FIG. 20 is a view showing display devices 1DG and 1DH according to another modification example of Embodiment 4 different from that shown in FIG. 19. In FIG. 20, a reference sign 2001 indicates a perspective view showing an outline of the display device 1DG, and a reference sign 2002 indicates a perspective view showing an outline of the display device 1DH.

As indicated by the reference sign 2001, the display device 1DG includes a light source 45 different from the light source 20, in addition to the configuration of the display device 1A. The light source 45 causes light to enter the light guide plate 10A from the lateral surface 11b opposed to the incident surface 11a. Such a display device 1DG also achieves effects similar to the display device 1A and the like.

As indicated by the reference sign 2002, the display device 1DH differs from the display device 1A in that the display device 1DH includes a light guide plate 10DH instead of the light guide plate 10A. The light guide plate 10DH differs from the light guide plate 10A in that the lateral surface 11b and positions of the incident surface 11a other than the position at which light from the light source 20 enters form reflective surfaces that reflect light.

In the display device 1DH, among the light entering the light guide plate 10DH from the light source 20, the light incident on the lateral surface 11b is reflected and further guided inside the light guide plate 10DH. The light reflected at the lateral surface 11b behaves as a light from a virtual light source 46 located on the opposite side of the light source 20 with respect to the lateral surface 11b, and forms an intersection point CA8 different from the intersection point CA1. Such a display device 1DH also achieves effects similar to the display device 1A and the like.

### Embodiment 5

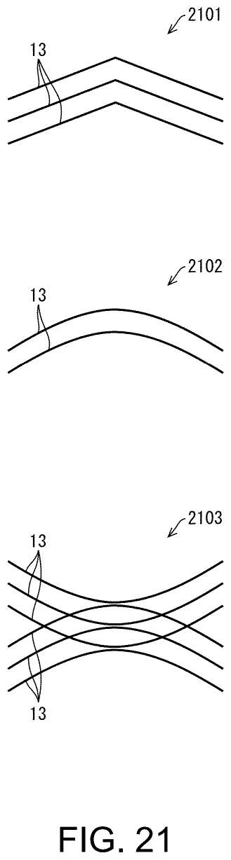

FIG. 21 is a view showing examples of the arrangement line 13 according to Embodiment 5. In the above embodiments, the arrangement line 13 is all a plurality of straight lines parallel to each other, but the arrangement line 13 is not limited thereto. The arrangement line 13 may be a straight line, a curve, a combination of two or more straight lines, a combination of two or more curves, or a combination of one or more straight lines and one or more curves. Specific examples of such arrangement lines 13 are indicated by reference signs 2101, 2102, and 2103 in FIG. 21.

In the display device 1A and the like, in the case where the arrangement line 13 has such shapes, it becomes possible to create an expression in which a stereoscopic image SI appears to move along the arrangement lines 13 by switching the position of the light source 20 to be turned on or moving the position at which the observer observes the stereoscopic image SI. Thus, the degree of freedom in expressing the stereoscopic image SI is improved.

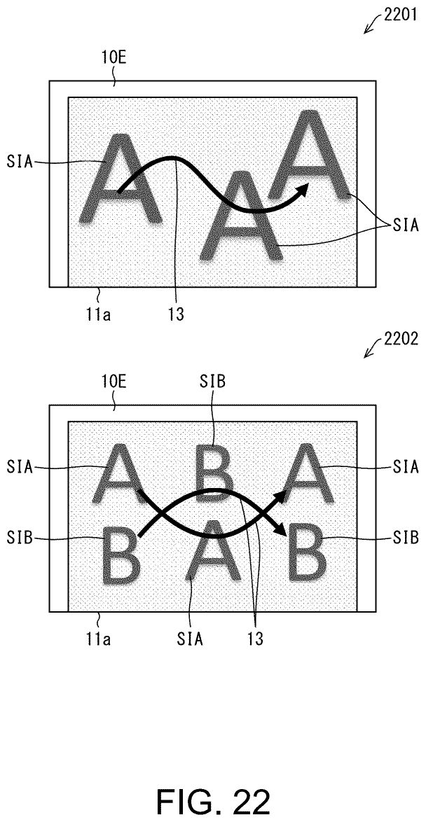

FIG. 22 is a view showing examples of a light guide plate 10E according to Embodiment 5. The light guide plate 10E differs from the light guide plate 10A in that the light guide plate 10E includes arrangement lines 13 that are not in a straight line shape. In FIG. 22, reference signs 2201 and 2202 indicate examples of the light guide plate 10E different from each other. In FIG. 22, stereoscopic images SIA and SIB appearing at a plurality of positions in the process of movement are shown in one view. Further, in FIG. 22, the arrangement lines 13 are illustrated as arrows indicating the movement directions of the stereoscopic images SIA and SIB.

In the light guide plate 10E indicated by the reference sign 2201, the arrangement line 13 on which the light deflecting parts 12 for displaying the stereoscopic image SIA are arranged has a shape combining a curve convex in a direction away from the incident surface 11a and a curve convex in a direction approaching the incident surface 11a. In this light guide plate 10E, as indicated by the reference sign 2201, the stereoscopic image SIA swings in a direction perpendicular to the incident surface 11a while moving in a direction along the incident surface 11a. By reducing the width and cycle of the swing in the direction perpendicular to the incident surface 11a, it is also possible to create a presentation in which the stereoscopic image SIA appears to move simulatingly in a straight line in a direction along the incident surface 11a.

In the light guide plate 10E indicated by the reference sign 2202, the arrangement line 13 on which the light deflecting parts 12 for displaying the stereoscopic image SIA are arranged has a shape of a curve convex in a direction approaching the incident surface 11a. On the other hand, the arrangement line 13 on which the light deflecting parts 12 for displaying the stereoscopic image SIB are arranged has a shape of a curve convex in a direction away from the incident surface 11a. The arrangement line 13 on which the light deflecting parts 12 for displaying the stereoscopic image SIA are arranged and the arrangement line 13 on which the light deflecting parts 12 for displaying the stereoscopic image SIB are arranged intersect each other. In this light guide plate 10E, as indicated by the reference sign 2202, the stereoscopic images SIA and SIB temporarily swap positions in a direction perpendicular to the incident surface 11a in the process of moving in a direction along the incident surface 11a.

### Embodiment 6

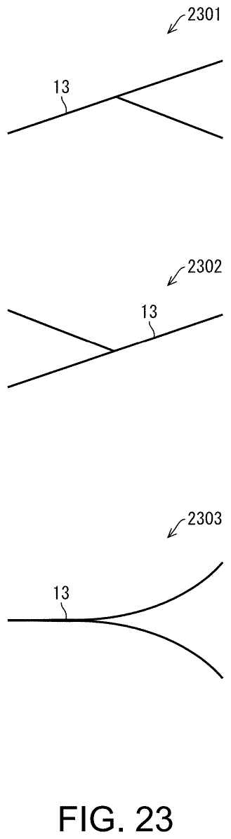

FIG. 23 is a view showing examples of the arrangement line 13 according to Embodiment 6. In the above embodiments, the arrangement line 13 is all a line having one start point and one end point respectively, but the arrangement line 13 is not limited thereto. The arrangement line 13 may include a branching point or a merging point of a plurality of lines. Specific examples of such an arrangement line 13 are indicated by reference signs 2301, 2302, and 2303 in FIG. 23.

In the display device 1A and the like, in the case where the arrangement line 13 has such shapes, it becomes possible to create an expression in which the stereoscopic image SI appears to split or merge along the arrangement lines 13 by switching the position of the light source 20 to be turned on or moving the position at which the observer observes the stereoscopic image SI. Thus, the degree of freedom in expressing the stereoscopic image SI is improved.

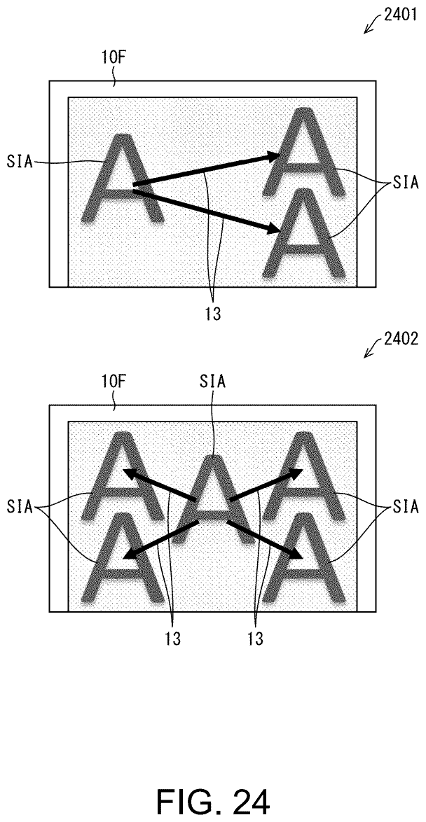

FIG. 24 is a view showing examples of a light guide plate 10F according to Embodiment 6. The light guide plate 10F differs from the light guide plate 10A in that the arrangement line 13 includes a branching point or a merging point of a plurality of lines. In FIG. 24, reference signs 2401 and 2402 indicate examples of the light guide plate 10F different from each other. In FIG. 24, the stereoscopic image SIA appearing at a plurality of positions in the process of movement is shown in one view. Further, in FIG. 24, the arrangement lines 13 are illustrated as arrows indicating the movement directions of the stereoscopic image SIA.

In the light guide plate 10F indicated by the reference sign 2401 in FIG. 24, the arrangement line 13 has a shape that branches in two directions from one end. In that case, although the stereoscopic image SIA is one image at the start point of movement, it splits into two and moves.

Further, in the light guide plate 10F indicated by the reference sign 2402 in FIG. 24, the arrangement line 13 has a shape that branches in four directions from one end. In that case, although the stereoscopic image SIA is one image at the start point of movement, it splits into four and moves.

The examples shown in FIG. 24 both involve a stereoscopic image SIA splitting into a plurality of images. However, as described above, according to the arrangement line 13 of Embodiment 6, a plurality of stereoscopic images can also be caused to merge. For example, in the examples shown in FIG. 24, by reversing one end and the other end, two or four stereoscopic images SIA can be caused to merge.

### Embodiment 7

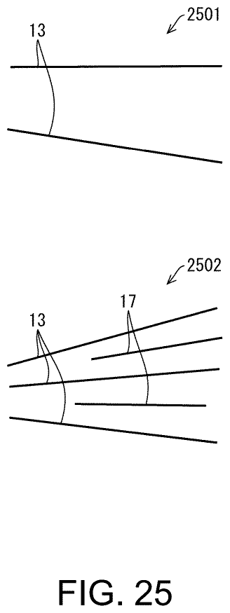

FIG. 25 is a view showing examples of the arrangement line 13 according to Embodiment 7. In FIG. 25, reference signs 2501 and 2502 indicate examples of the arrangement line 13 according to Embodiment 7 different from each other.

For example, as indicated by the reference sign 2501 in FIG. 25, the arrangement line 13 may include straight line regions that are not parallel to each other. In the display device 1A and the like, in the case where the arrangement line 13 has such a shape, it becomes possible to create an expression in which the stereoscopic image SI appears to expand or shrink along the arrangement lines 13 by switching the position of the light source 20 to be turned on or moving the position at which the observer observes the stereoscopic image SI. Thus, the degree of freedom in expressing the stereoscopic image SI is improved.

Further, in the case where there is a region in which the interval between the arrangement lines 13 becomes excessively wide because the arrangement lines 13 are not parallel to each other, for example, as indicated by the reference sign 2502 in FIG. 25, an auxiliary arrangement line 17 may also be added to this region. In that case, degradation in the image quality of the stereoscopic image SI can be suppressed while maintaining the degree of freedom in expressing the stereoscopic image SI.

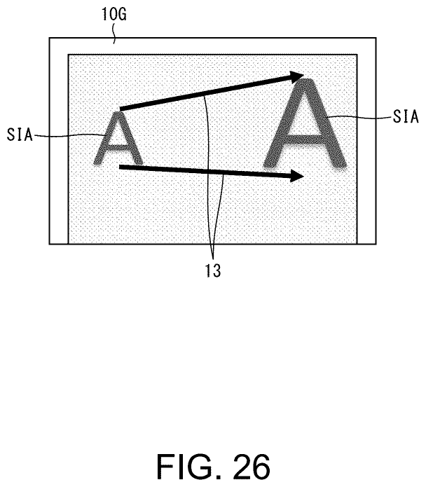

FIG. 26 is a view showing an example of a light guide plate 10G according to Embodiment 7. The light guide plate 10G differs from the light guide plate 10A in that the arrangement lines 13 are not parallel to each other. In FIG. 26, the stereoscopic image SIA appearing at a plurality of positions in the process of movement is shown in one view. Further, in FIG. 26, the arrangement lines 13 are illustrated as arrows indicating the movement direction of the stereoscopic image SIA.

In the light guide plate 10G shown in FIG. 26, the interval between the plurality of arrangement lines 13 widens as it goes from the start point to the end point of movement of the stereoscopic image SIA. In that case, the stereoscopic image SIA is expanded as it moves along the arrangement lines 13. Further, in the light guide plate 10G, contrary to the example in FIG. 26, the interval between the plurality of arrangement lines 13 may also narrow as it goes from the start point to the end point of movement of the stereoscopic image SIA. In that case, the stereoscopic image SIA shrinks as it moves along the arrangement lines 13.

### Embodiment 8

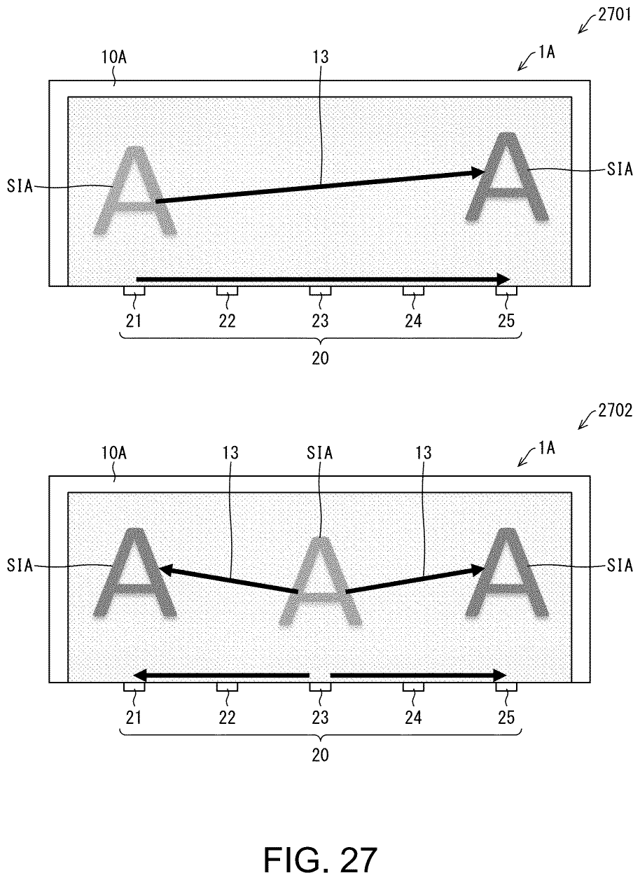

FIG. 27 is a view showing specific examples of a control on the light source 20 performed by the control part 30. In FIG. 27, reference signs 2701 and 2702 indicate different examples of the control on the light source 20 performed by the control part 30. In FIG. 27, the stereoscopic image SIA appearing at a plurality of positions in the process of movement is shown in one view. Further, in FIG. 27, the arrangement lines 13 are illustrated as arrows indicating the movement directions of the stereoscopic image SIA.

In the examples shown in FIG. 27, the control part 30 controls turn-on and turn-off of five light sources 21, 22, 23, 24, and 25 as the light source 20. The light sources 21, 22, 23, 24, and 25 are sequentially arranged in a linear pattern.

The control part 30 may control the light sources 21, 22, 23, 24, and 25 to turn on and turn off sequentially from one end to the other end of the region of the linear pattern. For example, as indicated by the reference sign 2701 in FIG. 27, the control part 30 first turns on the light source 21 only. Next, the control part 30 turns off the light source 21 and turns on the light source 22. Thereafter, the control part 30 sequentially performs turn-off of the light source 22 and turn-on of the light source 23, turn-off of the light source 23 and turn-on of the light source 24, and turn-off of the light source 24 and turn-on of the light source 25. With such a control, it is possible to realize a control in which the position of the light source 20 that causes light to enter the light guide plate 10A moves from one end to the other end of the region in which the light sources 20 are arranged in a linear pattern.

Further, the control part 30 may control the light sources 21, 22, 23, 24, and 25 to turn on and turn off sequentially from any point other than the one end and the other end of the region of the linear pattern toward both the one end and the other end.

For example, as indicated by the reference sign 2702 in FIG. 27, the control part 30 first turns on the light source 23 only. Next, the control part 30 turns off the light source 23 and turns on the light sources 22 and 24. Furthermore, the control part 30 turns off the light sources 22 and 24 and turns on the light sources 21 and 25. With such a control, it is possible to realize a control in which the position of the light source 20 that causes light to enter the light guide plate 10A moves from a point other than the both ends toward the both ends of the region in which the light sources 20 are arranged in a linear pattern.

The quantity of the light sources 20 controlled by the control part 30 is not limited to those described above. Further, the control part 30 may also cause the light sources 20 to emit light one by one or cause multiple light sources 20 to emit light at a time. Furthermore, the control part 30 may also gradually increase or decrease the quantity of the light sources 20 that emit light simultaneously.

The disclosure is not limited to the embodiments described above, and various changes may be made within the scope indicated in the claims. Embodiments obtained by appropriately combining technical means respectively disclosed in embodiments different from each other are also included in the technical scope of the disclosure.

### SUMMARY

The disclosure is also expressed as follows.

A light guide plate according to aspect 1 of the disclosure is a light guide plate which displays a stereoscopic image based on parallax. The light guide plate includes: an incident surface by which a light from a light source enters; an exit surface from which the light exits; and a plurality of light deflecting parts that cause the light entering from the incident surface and guided to exit from the exit surface by deflecting the light. The plurality of light deflecting parts are arranged on an arrangement line which is a linear arrangement region. A point on the exit surface that emits a first exit light deflected by the light deflecting part toward an angular range of irradiating to one eye and a vicinity thereof of an observer observing the exit surface from within an observation space of a predetermined range is defined as a first exit point. A point on the exit surface that emits a second exit light deflected by the light deflecting part toward an angular range of irradiating to the other eye and a vicinity thereof of the observer is defined as a second exit point. The plurality of light deflecting parts arranged on the arrangement line are provided such that a straight line passing through the first exit point and a center of the one eye and a straight line passing through the second exit point and a center of the other eye intersect each other to form an intersection point. The arrangement line is provided as a plurality of arrangement lines, and at least one of the arrangement lines includes a region that is not parallel to the incident surface.

In the light guide plate according to aspect 2 of the disclosure, in aspect 1, the intersection point is located on a depth side of the exit surface as viewed from the observer.

In the light guide plate according to aspect 3 of the disclosure, in aspect 1 or 2, each of the plurality of arrangement lines is a straight line, a curve, a combination of two or more straight lines, a combination of two or more curves, or a combination of one or more straight lines and one or more curves.

In the light guide plate according to aspect 4 of the disclosure, in any one of aspects 1 to 3, each of the plurality of arrangement lines includes a branching point or a merging point of a plurality of lines.

In the light guide plate according to aspect 5 of the disclosure, in any one of aspects 1 to 4, each of the plurality of arrangement lines includes a straight line region that is not parallel to each other.

In the light guide plate according to aspect 6 of the disclosure, in any one of aspects 1 to 5, the stereoscopic image includes a first stereoscopic image displayed by the light deflecting parts in a first partial region which is a region of a part of the light guide plate, and a second stereoscopic image displayed by the light deflecting parts in a second partial region which is a region different from the first partial region. The light deflecting parts are provided such that the first stereoscopic image and the second stereoscopic image are observable from within the same observation space.

In the light guide plate according to aspect 7 of the disclosure, in any one of aspects 1 to 5, the stereoscopic image includes a first stereoscopic image displayed by the light deflecting parts in a first partial region which is a region of a part of the light guide plate, and a second stereoscopic image displayed by the light deflecting parts in a second partial region which is a region different from the first partial region. The light deflecting parts are provided such that the observation space in which the first stereoscopic image is observable and the observation space in which the second stereoscopic image is observable are arranged at positions different from each other.

In the light guide plate according to aspect 8 of the disclosure, in any one of aspects 1 to 7, an angle formed between the incident surface and a region of each of the plurality of arrangement lines that is not parallel to the incident surface is 2.5° or more.

A display device according to aspect 9 of the disclosure includes: the light guide plate of any one of aspects 1 to 8; a plurality of light sources that cause light to enter the light guide plate from the incident surface; and a control part that controls the plurality of light sources.

In the display device according to aspect 10 of the disclosure, in aspect 9, the plurality of light sources are arranged in a linear pattern. The control part controls the plurality of light sources to turn on and turn off sequentially from one end to the other end of a region of the linear pattern.

In the display device according to aspect 11 of the disclosure, in aspect 9, the plurality of light sources are arranged in a linear pattern. The control part controls the plurality of light sources to turn on and turn off sequentially from any point other than one end and the other end of a region of the linear pattern toward both the one end and the other end.

A game machine according to aspect 12 of the disclosure includes the display device of any one of aspects 9 to 11.

An in-vehicle display according to aspect 13 of the disclosure includes the display device of any one of aspects 9 to 11.

What is claimed is:

1. A light guide plate which displays a stereoscopic image based on parallax, the light guide plate comprising:
an incident surface by which a light from a light source enters;
an exit surface from which the light exits; and
a plurality of light deflecting parts that cause the light entering from the incident surface and guided to exit from the exit surface by deflecting the light, wherein
the plurality of light deflecting parts are arranged on an arrangement line which is a linear arrangement region,
a point on the exit surface that emits a first exit light deflected by the light deflecting part toward an angular range of irradiating to one eye and a vicinity thereof of an observer observing the exit surface from within an observation space of a predetermined range is defined as a first exit point, a point on the exit surface that emits a second exit light deflected by the light deflecting part toward an angular range of irradiating to the other eye and a vicinity thereof of the observer is defined as a second exit point, and the plurality of light deflecting parts arranged on the arrangement line are provided such that a straight line passing through the first exit point and a center of the one eye and a straight line passing through the second exit point and a center of the other eye intersect each other to form an intersection point, and
the arrangement line is provided as a plurality of arrangement lines, and at least one of the arrangement lines comprises a region that is not parallel to the incident surface.

2. The light guide plate according to claim 1, wherein the intersection point is located on a depth side of the exit surface as viewed from the observer.

3. The light guide plate according to claim 1, wherein each of the plurality of arrangement lines is a straight line, a curve, a combination of two or more straight lines, a combination of two or more curves, or a combination of one or more straight lines and one or more curves.

4. The light guide plate according to claim 1, wherein each of the plurality of arrangement lines comprises a branching point or a merging point of a plurality of lines.

5. The light guide plate according to claim 1, wherein each of the plurality of arrangement lines comprises a straight line region that is not parallel to each other.

6. The light guide plate according to claim 1, wherein the stereoscopic image comprises a first stereoscopic image displayed by the light deflecting parts in a first partial region which is a region of a part of the light guide plate, and a second stereoscopic image displayed by the light deflecting parts in a second partial region which is a region different from the first partial region, and
the light deflecting parts are provided such that the first stereoscopic image and the second stereoscopic image are observable from within the same observation space.

7. The light guide plate according to claim 1, wherein the stereoscopic image comprises a first stereoscopic image displayed by the light deflecting parts in a first partial region which is a region of a part of the light guide plate, and a second stereoscopic image displayed by the light deflecting parts in a second partial region which is a region different from the first partial region, and
the light deflecting parts are provided such that the observation space in which the first stereoscopic image is observable and the observation space in which the second stereoscopic image is observable are arranged at positions different from each other.

8. The light guide plate according to claim 1, wherein an angle formed between the incident surface and a region of each of the plurality of arrangement lines that is not parallel to the incident surface is 2.5° or more.

9. A display device comprising:
the light guide plate according to claim 1;
a plurality of light sources that cause light to enter the light guide plate from the incident surface; and
a control part that controls the plurality of light sources.

10. The display device according to claim 9, wherein the plurality of light sources are arranged in a linear pattern, and
the control part controls the plurality of light sources to turn on and turn off sequentially from one end to the other end of the linear pattern.

11. The display device according to claim 9, wherein the plurality of light sources are arranged in a linear pattern, and
the control part controls the plurality of light sources to turn on and turn off sequentially from any point other than one end and the other end of the linear pattern toward both the one end and the other end.

12. A game machine comprising the display device according to claim 9.

13. A game machine comprising the display device according to claim 10.

14. A game machine comprising the display device according to claim 11.

15. An in-vehicle display comprising the display device according to claim 9.

16. An in-vehicle display comprising the display device according to claim 10.

17. An in-vehicle display comprising the display device according to claim 11.
